(19) United States
(12) Patent Application Publication
(10) Pub. No.: US 2016/0187171 A1
(43) Pub. Date: Jun. 30, 2016

(54) Reflector Array For Transit-Time Flow Measurement

(71) Applicant: Murray F. Feller, Micanopy, FL (US)

(72) Inventor: Murray F. Feller, Micanopy, FL (US)

(73) Assignee: ONICON, INC., Clearwater, FL (US)

(21) Appl. No.: 14/582,355

(22) Filed: Dec. 24, 2014

(51) Int. Cl. G01F 1/66

(52) U.S. Cl. CPC G01F 1/662

(57) ABSTRACT

Acoustic reflectors in a pipe can aid in defining an ultrasonic beam for a transit time flow measurement. Flow impedance associated with such reflectors can be minimized by using reflectors comprising an array of parallel reflective facets elongated transverse to an axis of the pipe and skewed with respect to the axis of the pipe. These facets may be formed in the wall of the pipe—e.g., by cutting grooves. Alternately, facet arrays may be formed in a separate low-profile body that is then attached to an inner wall of the pipe.

### BACKGROUND INFORMATION

Transit time flow sensors are sometimes configured to have ultrasonic transducers set perpendicular to the axis of a pipe through which flow is to be measured, as schematically depicted in FIG. 1. Two or more post reflectors are used to redirect acoustic signals from one transducer to another. Shortcomings of this approach include, inter alia, introduction of a substantial flow impedance; perturbation of flow conditions between the reflectors; and fabrication cost.

### BRIEF SUMMARY OF THE INVENTION

An object of the invention is to provide, in a transit time flow measurement, an acoustic reflector to replace the prior art post reflector with a structure having substantially less flow impedance.

Another object of the invention is to provide a transit-time flow measurement in which the ultrasonic beam direction is controlled by reflection without having a refraction component. This means that the beam properties remain constant over a wide range of fluid properties which contributes to the improved performance of the meter. This is particularly true when comparing the present invention to prior art employing non-wetted transducers mounted at an angle to the flow axis.

One aspect of the invention is that it provides an acoustic reflector disposed within a pipe and used in a transit time flow measurement apparatus in which an acoustic beam characterized by a selected wavelength is reflected from the acoustic reflector. A preferred acoustic reflector comprises an array of parallel reflective facets elongated transverse to an axis of the pipe and skewed with respect to the axis of the pipe. In each array each reflective facet extends along the axis of the pipe by a respective width greater than the selected wavelength. In a particular preferred embodiment each reflective facet in the array is a flat elongated rectangular sheet in which the elongation direction of the facet is perpendicular to the axis of the pipe.

Another aspect of the invention is that it provides a reflector for reflecting ultrasonic signals in a transit time flow measurement of fluid flowing along an axis of a pipe having an internal surface defining a circular cross-section. This acoustic reflector comprises an array of parallel grooves, each of which has a respective axis extending along a chord of the circular cross-section. In addition, each groove provides a respective reflective facet skewed with respect to the axis of the pipe and having a respective width greater than a wavelength of the ultrasonic signals.

Yet another aspect of the invention is that it provides an acoustic reflector for reflecting ultrasonic signals in a transit time flow measurement of fluid flowing along an axis of a pipe. This acoustic reflector comprises an array of parallel grooves formed in a body distinct from the pipe and attached to an internal surface of the pipe. Each of these grooves provides a respective reflective facet skewed with respect to the axis of the pipe and having a respective width greater than a wavelength of the ultrasonic signals.

Those skilled in the art will recognize that the foregoing broad summary description is not intended to list all of the features and advantages of the invention. Both the underlying ideas and the specific embodiments disclosed in the following Detailed Description may serve as a basis for alternate arrangements for carrying out the purposes of the present invention and such equivalent constructions are within the spirit and scope of the invention in its broadest form. Moreover, different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1 is a longitudinal schematic cross-sectional view of a prior art transit time flow sensor in which an acoustic beam is defined by post reflectors.

FIG. 2 is a schematic cross-sectional view in a plane including a pipe axis, of an acoustic reflector of the invention comprising a plurality of grooves cut into a wall of the pipe.

FIG. 3 is a schematic cross-sectional view, in a plane perpendicular to the pipe axis, of the acoustic reflector of FIG. 2 formed along a chord of the pipe and cut into the wall thereof.

FIG. 4 is a longitudinal schematic view of an arrangement in which reflections of an acoustic beam from two multi-groove reflectors and from two selected portions of an interior pipe wall are used to generate a quasi-helical acoustic beam.

FIG. 5 is a schematic cross-sectional view showing a portion of a quasi-helical acoustic path, the section indicated by the double-headed arrow 5-5 in FIG. 4.

FIG. 6 is a schematic cross-sectional view, similar to that of FIG. 2, of an acoustic reflector for focusing an acoustic beam.

FIG. 7A is a schematic longitudinal section of a reflector array, wherein variation of the widths of reflecting facets making up the acoustic reflector is used to focus an acoustic beam.

FIG. 7B is a schematic longitudinal section of a reflector array wherein variation of the curvatures of reflecting facets making up the acoustic reflector is used to focus an acoustic beam.

FIG. 8 is a schematic cross-sectional view, in a plane including a pipe axis, of an acoustic reflector of the invention comprising a plurality of grooves formed in a separate body attached to a wall of the pipe.

FIG. 9 is a perspective view of the separate reflector body of FIG. 8.

### DETAILED DESCRIPTION OF A PREFERRED EMBODIMENT

In studying this Detailed Description, the reader may be aided by noting definitions of certain words and phrases used throughout this patent document. Wherever those definitions are provided, those of ordinary skill in the art should understand that in many, if not most, instances such definitions apply both to preceding and following uses of such defined words and phrases.

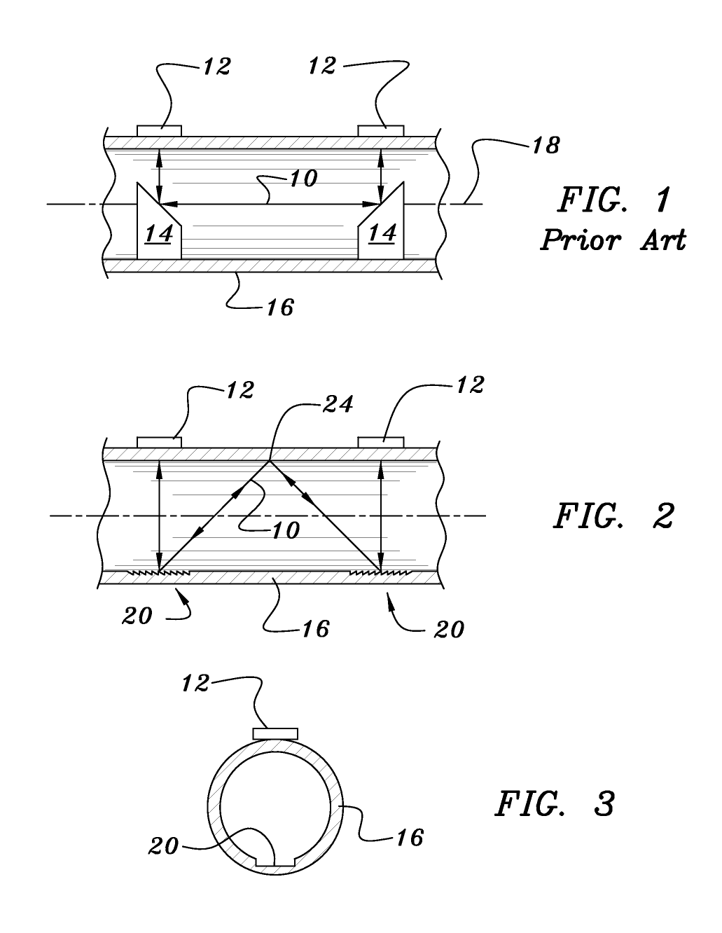

A prior art transit time flow measurement depicted in FIG. 1 employs post reflectors 14 to define an acoustic path 10, indicated by arrowheaded lines and extending between two transducers 12 that transmit and receive ultrasonic signals characterized by a wavelength associated with a resonant frequency of the transducers. The post reflectors 14 cooperate with transducers 12 mounted on an outer surface of a pipe 16 to generate an acoustic beam 10 having a portion extending along an axis 18 of the pipe 16. This arrangement is advantageous in that: it is compatible with the use of externally mounted transducers generating and receiving signals along lines perpendicular to the pipe axis; and it allows for sampling a central portion of the flow. The arrangement is disadvantageous in that the post reflectors 14 provide significant flow impedance, perturb a portion of the flow that is being measured, and are expensive to implement.

Turning now to FIG. 2, one finds a schematic depiction of a transit time flow measurement employing an embodiment of the invention. Here an acoustic beam 10 extends between two transducers 12 mounted on an outside surface of a pipe 16 so as to project ultrasonic signals diametrically across the pipe. The transducers may be held in position by any of a number of mounting approaches. Moreover, the arrangement is not limited to any particular transducer mounting scheme so that the transducers 12 may be external to the pipe, attached at a thinned window portion of the pipe or wetted.

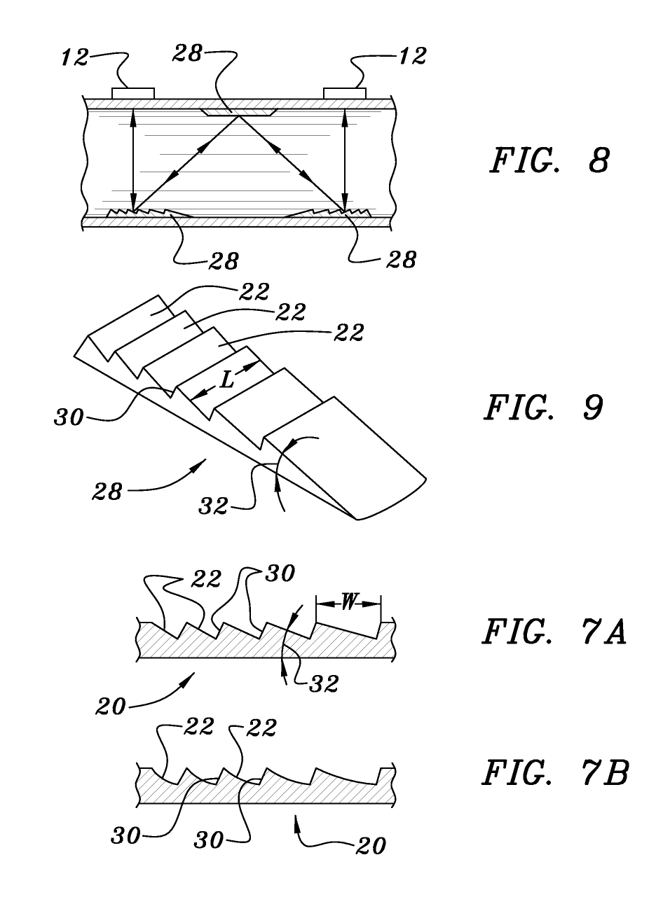

In the depiction of FIG. 2, an ultrasonic impulse generated by one transducer crosses the pipe along a diameter and is reflected from a first acoustic reflector 20 comprising a plurality of parallel reflecting facets 22 (shown best in FIGS. 7A and 7B) that are skewed with respect to the pipe axis 18 by a first selected angle and that have a width, W, longer than the characteristic wavelength associated with the resonant frequency of the transducer. The beam is then reflected from a selected point 24 on an internal wall of the pipe and from a second acoustic reflector 20 comprising a second plurality of reflecting facets 22 skewed with respect to the pipe axis by a second selected angle before crossing the pipe along a diameter and impinging upon the second transducer 12. In this case the individual reflecting facets 22 may all be flat rectangles elongated perpendicular to the axis of the pipe, and having the same width. Moreover, the selected angles characterizing the two arrays are supplementary.

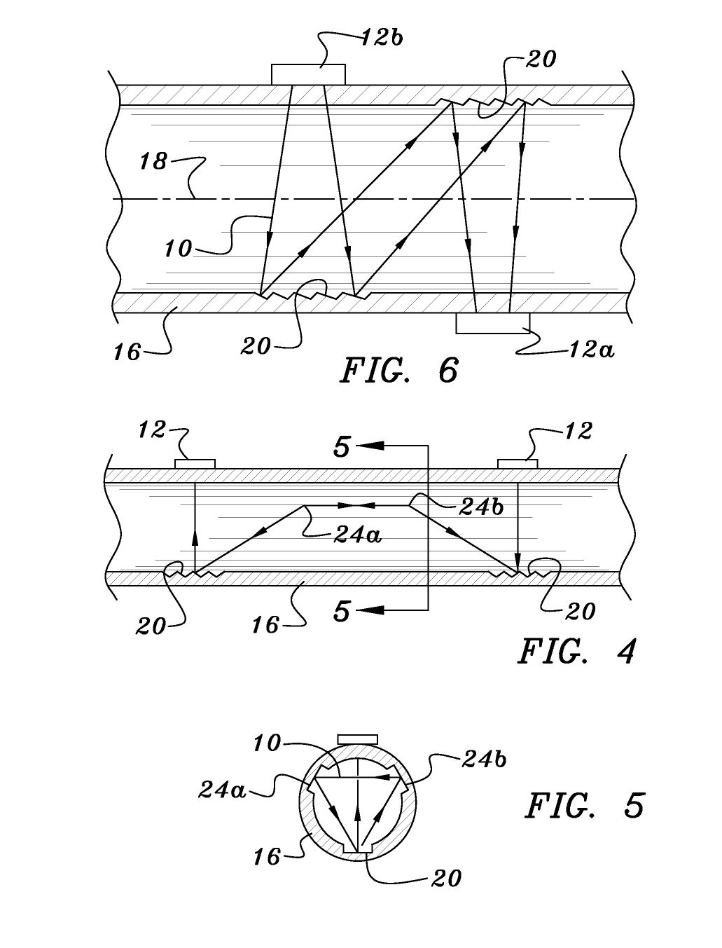

The reader who is skilled in forming beams used in the transit time measurement arts will recognize that many paths more complex than those indicated in FIG. 2 may be used in a transit time measurement. In particular, FIG. 4 and FIG. 5 depict an ultrasonic beam having a generally quasi-helical shape selected to obtain a better sampling of the flow rate. The present invention provides for such arrangements by angling the grooved acoustic reflectors 20 so that individual reflecting facets 22 are transverse to but not perpendicular to the axis of the pipe, but are instead at an angle known to generate the desired quasi-helical beam. The beam in this example reflects from the two arrays 20 and from flat reflecting surfaces 24a, 24b cut into the pipe 16.

Individual reflecting facets in the embodiment of the acoustic reflectors depicted in FIG. 2 may be formed by cutting grooves 26 into the pipe 16. In many such arrays all the grooves are chordal and extend perpendicular to a pipe diameter for some selected distance, as depicted in FIG. 3. In a structure of this sort, one must trade off improved reflector efficiency (obtained by cutting out more of the pipe wall) against a requirement for minimum allowable pipe strength.

Turning now to FIG. 6, one finds another embodiment of the invention in which the acoustic reflectors 20 are constructed so as to focus an acoustic beam 10 generated by a first transducer 12a onto a second transducer 12b and to thereby reduce signal losses associated with beam spreading.

One approach to providing a focusing reflector is depicted in FIG. 7A where the widths (indicated by the character W) and the inclination angle 32 of the individual reflecting facets 22 in the array 20 vary along the array. Another approach, depicted in FIG. 7B, calls for using individual reflecting facets that are curved about their elongation direction.

Preferably, the shapes of the grooves and the angle of incidence of the acoustic beam are selected so that the acoustic beam reflects off only one 22 of two 22, 30 facets defining each groove. It may be noted that if the groove geometry is such that there are appreciable reflections from the nominally shadowed surface 30 these reflections are lost from the reflected beam and result in a reduction in efficiency of the reflector.

Turning now to FIG. 8, one finds a second embodiment of the invention wherein acoustic reflectors 20 comprise respective arrays of reflecting facets 22 formed in separate bodies 28 that are attached to internal pipe walls by solder, adhesive, a screw extending through the wall of the pipe or any other known means. Because the attached body extends inwardly of the pipe wall, this embodiment has higher flow impedance than does a reflector cut into the pipe wall. However, it should be clear that this embodiment does not compromise the strength of the pipe.

The angular settings of the reflecting facets 22 and the width, W, and length, L, of the facets in the separate body embodiment are chosen in the same manner as in the first embodiment. Thus, many different arrays may be formed other than the one depicted in FIG. 9 as having a single facet length L and width W for all facets in the array.

Although the present invention has been described with respect to several preferred embodiments, many modifications and alterations can be made without departing from the invention. Accordingly, it is intended that all such modifications and alterations be considered as being within the spirit and scope of the invention as defined in the attached claims.

1. A transit time flow measurement apparatus in which an acoustic beam characterized by a selected acoustic wavelength is reflected from an acoustic reflector disposed within a pipe, the acoustic reflector comprising an array of parallel reflective facets elongated transverse to a longitudinal axis of the pipe and skewed with respect thereto, wherein each reflective facet extends along the longitudinal axis of the pipe by a respective width greater than the selected wavelength.

2. The acoustic reflector of claim 1 wherein each reflective facet is characterized by a respective inclination angle.

3. (canceled)

4. (canceled)

5. (canceled)

6. (canceled)

7. (canceled)

8. (canceled)

9. A transit time flow measurement apparatus for measuring flow of fluid flowing along a longitudinal axis of a pipe having an internal surface defining a circular cross-section, the apparatus comprising a reflector for reflecting ultrasonic signals, the reflector comprising an array of parallel facets in the internal surface, each facet having a respective axis extending along a chord of the circular cross-section, each respectfully skewed with respect to the longitudinal axis of the pipe and having a respective width greater than a wavelength of the ultrasonic signals.

10. The acoustic reflector of claim 9 wherein each reflective facet is characterized by a respective inclination angle.

11. (canceled)

12. (canceled)

13. (canceled)

14. (canceled)

15. (canceled)

16. (canceled)

17. (canceled)

18. (canceled)

19. (canceled)

20. (canceled)
